(19) United States
(12) Patent Application Publication
(10) Pub. No.: US 2019/0384319 A1
(43) Pub. Date: Dec. 19, 2019

(54) MOVING BODY ASSISTANCE SYSTEM AND MOVING BODY ASSISTANCE METHOD

(71) Applicant: HONDA MOTOR CO., LTD., Tokyo (JP)

(72) Inventors: Yoshiaki Sakagami, Wako-shi (JP); Taku Osada, Wako-shi (JP)

(21) Appl. No.: 16/434,204

(22) Filed: Jun. 7, 2019

(30) Foreign Application Priority Data
Jun. 14, 2018 (JP) 2018-113451

(51) Int. Cl. G05D 1/02

(52) U.S. Cl. CPC G05D 1/0276; G05D 1/0246; G01C 21/3647; G05D 1/0274; G05D 1/024

(57) ABSTRACT

A moving body assistance system that generates map information indicating a map in which is recorded a travelable region of a moving body, based on travel information concerning a plurality of vehicles; calculates a travel pattern for passing through a point of concern while travelling in the travelable region, based on the map information; and sets the moving body attempting to pass through the point of concern as an assistance target to be assisted with travelling in accordance with the calculated travel pattern.

### CROSS-REFERENCE TO RELATED APPLICATION

This application is based upon and claims the benefit of priority from Japanese Patent Application No. 2018-113451 filed on Jun. 14, 2018, the contents of which are incorporated herein by reference.

### BACKGROUND OF THE INVENTION

### Field of the Invention:

The present invention relates to a moving body assistance system and a moving body assistance method for assisting with travel of a moving body.

### Description of the Related Art:

A conventional moving body assistance system is known that assists with the travel of a moving body. For example, technology has been proposed for identifying road conditions based on information indicating a travel trajectory of a vehicle, and providing a user of the moving body with these road conditions.

Japanese Laid-Open Patent Publication No. 2014-241090 proposes an apparatus that, based on a plurality of pieces of probe data, identifies road conditions that cannot be identified by a single piece of probe data. For example, there is a description of, after an irregular route is first travelled, if there is no travel trajectory for travelling on a regular route, it is determined that this road section is restricted.

### SUMMARY OF THE INVENTION

It should be noted that, with the apparatus described in Japanese Laid-Open Patent Publication No. 2014-241090, the process stops at determining whether a travel route has been passed through, and it is impossible to provide detailed travel assistance that includes a travel scenario of passing through while avoiding obstacles in front, for example.

The present invention takes the above situation into consideration, and it is an objective of the present invention to provide a moving body assistance system and moving body assistance method capable of performing detailed travel assistance using travel information concerning a plurality of moving bodies.

In order to realize this objective, the moving body assistance system according to the present invention comprises an information acquiring unit configured to acquire travel information of a moving body; a map information generating unit configured to generate map information; a travel state estimating unit configured to estimate a travelable region for the moving body at a point of concern in the map information and a travel pattern for passing through the travelable region, using a plurality of pieces of the travel information acquired by the information acquiring unit; an assistance target setting unit configured to set a moving body attempting to pass through the point of concern as an assistance target; and an assisting unit configured to provide the moving body set by the assistance target setting unit with the travel pattern estimated by the travel state estimating unit.

In this way, the travel pattern for passing through the point of concern while travelling in the travelable region is calculated and assistance is provided for travelling in accordance with this travel pattern, and therefore it is possible to perform detailed travel assistance using the travel information concerning a plurality of moving bodies.

Information forming the travel pattern may include at least route information indicating a travel route of the moving body.

The information forming the travel pattern may further include velocity information indicating a travel velocity of the moving body.

It is preferable that the travel state estimating unit is configured to estimate a plurality of types of the travel pattern at the point of concern, and the moving body assistance system further comprises a travel pattern correspondence unit configured to select an optimal travel pattern to be provided to the moving body, from among the estimated plurality of types of travel patterns.

The plurality of types of travel patterns may include two or more of an average travel pattern obtained as an average of a plurality of the travel patterns within a predetermined time interval at the point of concern, a high fuel efficiency travel pattern obtained by extracting the travel pattern having the best fuel efficiency among the plurality of the travel patterns within a predetermined time interval at the point of concern, and a smooth travel pattern obtained by extracting a travel pattern with the least manipulation amount of the moving body among the plurality of the travel patterns within a predetermined time interval at the point of concern.

It is preferable that the travel state estimating unit is configured to acquire an occurrence of an event at the point of concern, and estimate an avoidance travel pattern that avoids the event, as one of the plurality of types of travel patterns.

The moving body assistance system may further comprise a traffic information acquiring unit configured to acquire travel road traffic information, and the traffic information acquiring unit may be configured to store event information included in the acquired travel road traffic information in association with the map information.

When the event is accident information of the moving body, the traffic information acquiring unit may be configured to store the accident information in the map information separately from other events.

When a degree of freedom of the travel pattern in the travelable area is high, the travel pattern correspondence unit may be configured to compare an accident travel pattern, which is the travel pattern when the accident information has occurred, to current travel information of the moving body, and when it is determined that there is a high correlation between the current travel information of the moving body and the accident travel pattern, the travel pattern correspondence unit may be configured to select a travel pattern differing from the accident travel pattern.

The travel state estimating unit may be configured to calculate a degree of travel freedom based on a distribution of a plurality of pieces of the travel information of the travelable region.

The travel state estimating unit may be configured to estimate the travel pattern by selecting the travel information that satisfies a predetermined condition from among the plurality of pieces of the travel information at the point of concern.

The predetermined condition may include any one of the same time of day, day of the week, month, and weather condition.

It is preferable that the travel information includes route information and velocity information of one moving body detected by the one moving body.

The travel information may include fuel efficiency information detected or calculated by the one moving body.

The travel information may include at least one of weight, body type, tire type, and control apparatus type of the moving body as data of the moving body.

The moving body assistance system may further comprise an external field recognizing unit configured to recognize an external field of one moving body; and a behavior analyzing unit configured to analyze travel behavior of another moving body, by tracking the other moving body sequentially recognized by the external field recognizing unit, and the information acquiring unit may be configured to acquire the travel information of the other moving body based on a result of the analysis by the behavior analyzing unit.

After losing sight of the other moving body during the tracking, the behavior analyzing unit may be configured to determine whether a newly detected moving body is the same as the other moving body, and if the moving bodies are the same, the behavior analyzing unit may be configured to perform interpolation between routes obtained before and after the other moving body was lost sight of.

The moving body assistance system may further comprise a position correcting unit configured to correct a position of the one moving body or a position of the other moving body, based on a position of a static object recognized by the external field recognizing unit.

The moving body assistance system may comprise a server apparatus including the map information generating unit, the travel state estimating unit, the assistance target setting unit, and the assisting unit, and the moving body may be a vehicle configured to travel on an outdoor road, include the information acquiring unit, and be configured to perform information communication with the server apparatus.

The moving body assistance system may comprise a server apparatus including the map information generating unit, the travel state estimating unit, the assistance target setting unit, and the assisting unit, and the moving body may be a robot configured to move indoors, include the information acquiring unit, and be configured to perform information communication with the server apparatus.

Furthermore, in order to realize the above objective, the moving body assistance method according to the present invention is executed by one or more computers, and comprises an acquisition step of acquiring travel information of a moving body; a generation step of generating map information; an estimation step of estimating a travelable region for the moving body at a point of concern in the map information and a travel pattern for passing through the travelable region, using a plurality of acquired pieces of the travel information; and a setting step of setting a moving body attempting to pass through the point of concern as an assistance target that is to be assisted with travelling in accordance with the estimated travel pattern.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is shows an overall configuration of a moving body assistance system according to an embodiment of the present invention;

FIG. 2 is a block diagram of a driving assistance apparatus mounted in a vehicle shown in FIG. 1;

FIG. 3 is a block diagram of the server apparatus shown in FIG. 1;

FIG. 4 shows an example of a data structure of the shared-experience map information;

FIG. 5 is a first flow chart provided to describe an operation of the moving body assistance system shown in FIG. 1;

FIG. 6 shows an example of a travel scenario in front of a vehicle;

FIGS. 7A and 7B shows change over time of travel routes;

FIGS. 8A, 8B and 8C show an example of a travel pattern calculation method;

FIG. 9 shows an example of a data structure of the travel pattern information;

FIG. 10 is a second flow chart provided to describe an operation of the moving body assistance system shown in FIG. 1;

FIGS. 11A and 11B show an example of a calculation method for a travel route of another vehicle; and

FIG. 12 shows an example of driving assistance in the travel scenario of FIG. 6.

### DESCRIPTION OF THE PREFERRED EMBODIMENTS

### [Description of the Moving Body Assistance System 10]

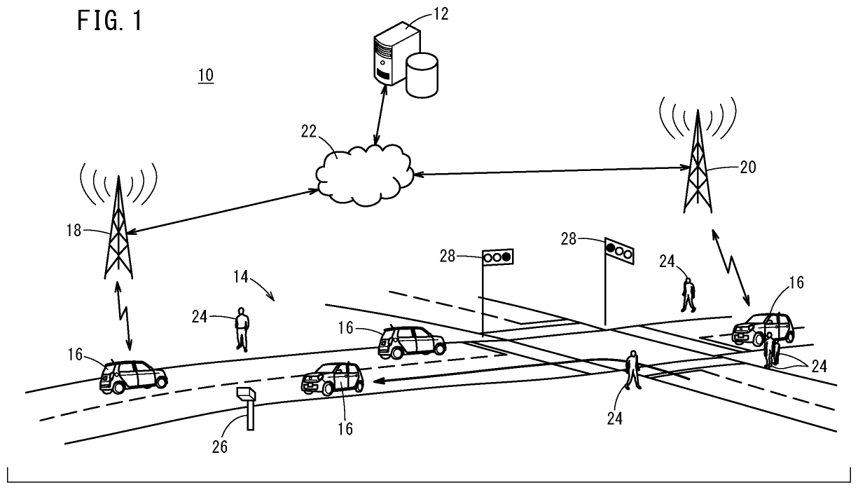

FIG. 1 shows an overall configuration of a moving body assistance system 10 according to an embodiment of the present invention. The moving body assistance system 10 is a system that assists with travel of a moving body (e.g., a vehicle 16), and includes a server apparatus 12 and a plurality of moving bodies (the four vehicles 16 in the example of the present drawing) in a traffic area 14. The moving bodies are not limited to the vehicles 16, and include apparatuses that are capable of performing information communication with the server apparatus 12 and capable of moving. For example, people who move while carrying an information processing terminal can be moving bodies.

Several (two in the example of the present drawing) base stations 18 and 20 are provided in the traffic area 14. The base stations 18 and 20 relay communication between each of the vehicles 16 and the server apparatus 12. The vehicles 16 and the server apparatus 12 are connected to each other via a wide area communication network 22 (WAN: Wide Area Network).

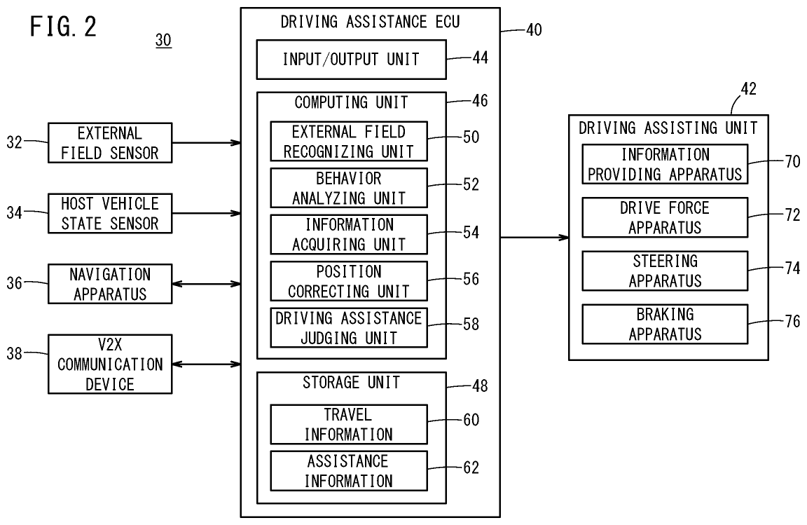

In addition to the vehicles 16, pedestrians 24, roadside apparatuses 26, traffic signals 28, and the like are present in the traffic area 14. The vehicles 16 and the pedestrians 24 correspond to parties (referred to below as traffic participants) that participate in the traffic within the traffic area 14. The vehicles 16 are provided with driving assistance apparatuses 30 (FIG. 2) that provide driving assistance to the vehicles 16 during travel.

### [Configuration of the Driving Assistance Apparatus 30]

FIG. 2 is a block diagram of a driving assistance apparatus 30 mounted in a vehicle 16 shown in FIG. 1. The driving assistance apparatus 30 includes an external field sensor 32, a host vehicle state sensor 34, a navigation apparatus 36, a V2X communication device 38, an electronic control unit (referred to below as a driving assistance ECU 40), and a driving assisting unit 42 (assistance means).

The external field sensor 32 acquires information (referred to below as external field information) indicating the state outside of the vehicle 16, and outputs this external field information to the driving assistance ECU 40. The external field sensor 32 is configured by one or a combination of a camera, a radar, and a LIDAR (Light Detection and Ranging/Laser Imaging Detection and Ranging).

The host vehicle state sensor 34 acquires information (referred to below as the host vehicle state information) indicating the state of the vehicle 16, and outputs this host vehicle state information to the driving assistance ECU 40. The host vehicle state sensor 34 includes various sensors that detect the behavior of the vehicle 16, such as a velocity sensor, acceleration sensor, steering angle sensor, yaw rate sensor, position sensor, and direction sensor. The host vehicle state sensor 34 also includes sensors that detect the manipulation amounts of driving manipulations made by the driver (acceleration opening amount sensor, brake opening amount sensor, steering amount sensor, and the like). Alternatively, the host vehicle state sensor 34 may include sensors that detect the activity (looking away or the like) of the user or biometric information (e.g., heart rate or alertness) of the user.

The navigation apparatus 36 includes a user interface (e.g., a touch panel display, a speaker, and a microphone) and a satellite positioning apparatus that detects the current position of the vehicle 16. The navigation apparatus 36 calculates a route to a designated destination, based on the current position of the vehicle 16 or a position designated by the user, and output it to the driving assistance ECU 40.

The V2X communication device 38 receives external information via communication with the server apparatus 12, communication with other vehicles 16 in the area (vehicle-to-vehicle communication, so-called V2V communication), or communication with roadside apparatuses 26 in the area (vehicle-to-road communication, so-called V2R communication), and outputs information concerning the vehicle 16 itself to the driving assistance ECU 40.

The driving assistance ECU 40 is a calculating device formed from one or more computers that include an input/output unit 44, a computing unit 46, and a storage unit 48.

Each signal from the external field sensor 32, the host vehicle state sensor 34, the navigation apparatus 36, and the V2X communication device 38 is input to the driving assistance ECU 40 via the input/output unit 44. Each signal from the driving assistance ECU 40 is output to the driving assisting unit 42 via the input/output unit 44. The input/output unit 44 includes an A/D conversion circuit (not shown in the drawings) that converts analog signals input thereto into digital signals.

The computing unit 46 performs a computation process using each signal input via the input/output unit 44, and generates a control signal corresponding to each unit of the driving assisting unit 42 based on the obtained computation result. The computing unit 46 functions as an external field recognizing unit 50, a behavior analyzing unit 52, an information acquiring unit 54, a position correcting unit 56, and a driving assistance judging unit 58.

The function of each unit in the computing unit 46 is realized by reading a program stored in advance in the storage unit 48 (or acquired by communication with the outside).

The storage unit 48 includes a RAM (Random Access Memory) that stores temporary data to be used in the computation process performed by the computing unit 46 and a ROM (Read Only Memory) that stores execution programs, tables, or maps. The storage unit 48 stores travel information 60 and assistance information 62 (both of which are described further below).

The driving assisting unit 42 performs a driving assistance operation (e.g., output of information to the user or travel control of the vehicle 16) for the vehicle 16, in response to control instructions (a signal) from the driving assistance ECU 40. Specifically, the driving assisting unit 42 includes an information providing apparatus 70, a drive force apparatus 72, a steering apparatus 74, and a braking apparatus 76.

The information providing apparatus 70 is an HMI (Human Machine Interface) apparatus formed by a display or a speaker, for example, and outputs various types of information for assisting with the driving into the inside of the vehicle 16. Alternatively, the information providing apparatus 70 may be a notification apparatus that provides audio or visual notification to the outside of the vehicle 16.

The drive force apparatus 72 generates a traction drive force (torque) of the vehicle 16 according to a traction control value from the driving assistance ECU 40, and transmits this traction drive force to the wheels either direction or indirectly via a transmission. The steering apparatus 74 changes the orientation of the wheels (steered wheels) according to the traction control value from the driving assistance ECU 40. The braking apparatus 76 brakes the wheels according to the traction control value from the driving assistance ECU 40.

### [Configuration of the Server Apparatus 12]

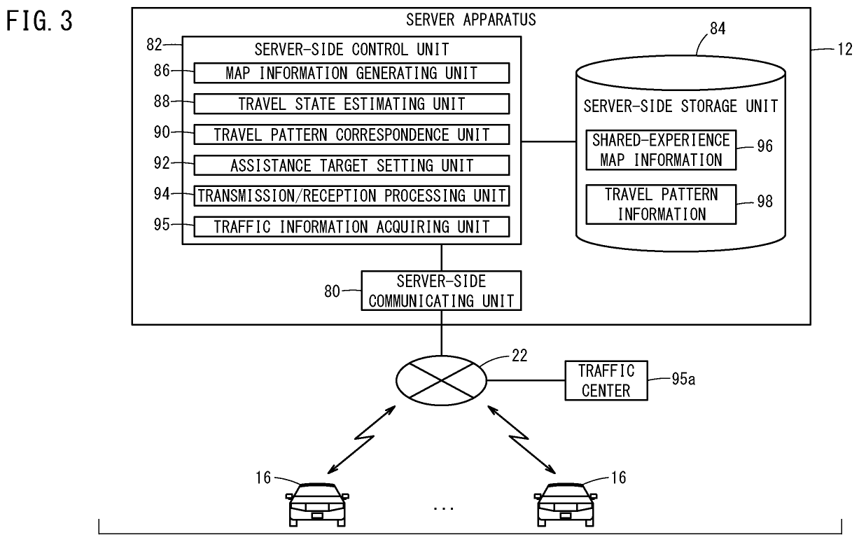

FIG. 3 is a block diagram of the server apparatus 12 shown in FIG. 1. The server apparatus 12 is a computer that processes and accumulates the travel information 60 (see FIG. 2) transmitted from the driving assistance apparatuses 30 of the plurality of vehicles 16. Specifically, the server apparatus 12 is formed to include a server-side communicating unit 80, a server-side control unit 82, and a server-side storage unit 84.

The server-side communicating unit 80 is an interface that transmits and receives electrical signals to and from an external apparatus. In this way, the server-side communicating unit 80 receives the travel information 60 from the vehicle 16 and transmits the assistance information 62 to the vehicle 16, via the base station 18 (20) and the wide area communication network 22.

The server-side control unit 82 is formed by a processing computation apparatus that includes a CPU. The server-side control unit 82 functions as a map information generating unit 86, a travel state estimating unit 88, a travel pattern correspondence unit 90, an assistance target setting unit 92, and a transmission/reception processing unit 94 (assisting unit), by reading and executing programs stored in a memory (not shown in the drawings).

The server-side storage unit 84 is non-transitory, and is formed by a computer-readable storage medium. The server-side storage unit 84 stores shared-experience map information 96 (map information) and travel pattern information 98.

The map information generating unit 86 generates information (the shared-experience map information 96) indicating a map in which the state of the traffic area 14 is recorded, based on the travel information 60 acquired from each of the plurality of vehicles 16 (the information acquiring unit 54 in FIG. 2).

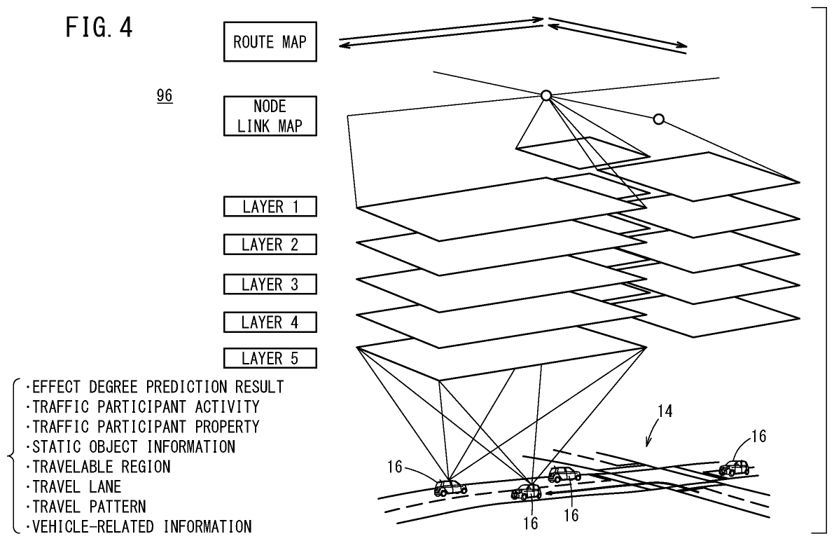

FIG. 4 shows an example of a data structure of the shared-experience map information 96. This shared-experience map information 96 is formed with a data structure in which a plurality of data layers are stacked on a foundational map (dynamic map) of a road network. The foundational map includes a route map of the road network and a node link map applied to a navigation system. The map information generating unit 86 does not need to include the foundational map, and may automatically generate the travel route according to the travelable regions and travel patterns described further below. The shared-experience map information 96 includes, as specific data layers in order from the bottom layer to the top layer, vehicle-related information, travel patterns, travel lanes, travelable regions, static object information, traffic participant properties, traffic participant activity, and effect degree prediction results.

The “vehicle-related information” refers to information that relates to the travel of the vehicle 16, and includes the steering amount, activity, and biometric information of the driver. Alternatively, the “vehicle-related information” may include at least one of the weight, body type, tire type, and control apparatus type of the vehicle 16 as the data of the moving body (vehicle 16). The “vehicle-related information” is acquired from the information included in the travel information 60 of the vehicle 16, for example. The “travel pattern” is information indicating the travel pattern of the vehicle 16 estimated by the travel state estimating unit 88, and this travel pattern includes route information indicating the route of the vehicle 16 and velocity information indicating the velocity of the vehicle 16.

The “travel lane” refers to information indicating the state of the road, and includes the position of lane marks, direction, type, speed limit, stop lines, and signs, for example. The “travelable region” is information indicating the area (positions of left and right boundary lines) where travel of the vehicle 16 is permitted as computed by the travel state estimating unit 88, aside from the travel route described above, and indicates locations where travel is temporarily impossible due to construction or the like as impossible regions. The “static object information” refers to information concerning static objects arranged permanently or temporarily. Examples of static objects include traffic signals, signs, billboards, and parked vehicles.

The “traffic participant property” is information including the type, position, orientation, date and time, and number gathered, for example. The “traffic participant activity” corresponds to an occurrence probability calculated based on a plurality of input variables including position, date and time, and frequency, for example. The “effect degree estimation result” corresponds to an effect degree calculated based on a plurality of input variables including position, date and time, frequency, and imagined scenario, for example.

### [Operation of the Moving Body Assistance System 10]

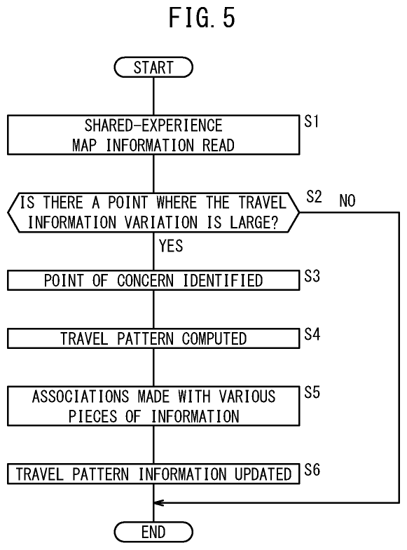

The moving body assistance system 10 according to the present embodiment is configured as described above. The following describes a first operation (travel pattern information 98 estimation operation) of the moving body assistance system 10, while referencing the flow chart of FIG. 5.

At step S1, the server-side control unit 82 reads from the server-side storage unit 84 the shared-experience map information 96 (time series of maps) in a predetermined time range.

At step S2, the server-side control unit 82 analyzes the shared-experience map information 96 in the predetermined time range, and determines whether there is a geographical point where there is a large statistical variation in the travel information 60 acquired from the plurality of vehicles 16. The travel information 60 is received from the vehicles 16, and includes the host vehicle state information and the other vehicle state information, described further below, acquired by the information acquiring unit 54 (see FIG. 2) while the vehicles 16 travel. The travel information 60 is configured to include the route information and the velocity information of the vehicles 16, and further includes fuel efficiency information in the present embodiment.

Each vehicle 16 travels in the same manner at the same locations on the road network, and therefore there is little statistical variation in the travel information 60 of each vehicle 16. On the other hand, when an event such as construction has occurred, the travel routes of the vehicles 16 differ even at the same locations on the road network, and therefore there is a large amount of statistical variation. The following is a detailed description of the statistical variation of the travel information 60.

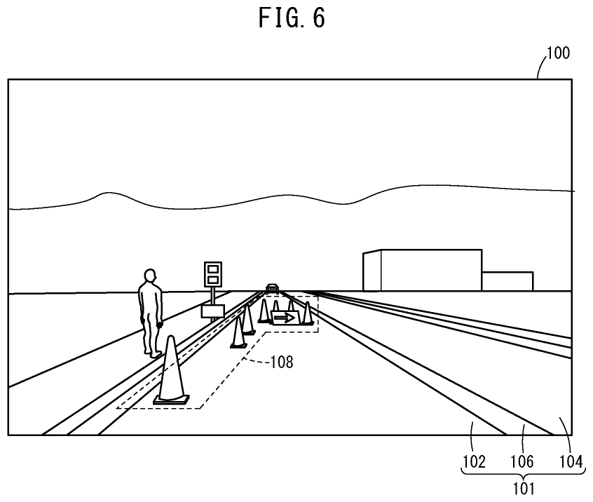

FIG. 6 shows an example of a travel scenario 100 in front of a vehicle 16. This drawing shows a road 101 in a geographical region where it is determined that automobiles drive on the “left side” of the road. The two-lane road 101 is formed by a travel lane 102 on which the vehicle 16 is travelling and an opposing lane 104. The travel lane 102 and the opposing lane 104 are separated by a lane mark 106 that is a continuous line. A road construction region (referred to below as a construction area 108) is present in front of the vehicle 16 in the travel lane 102.

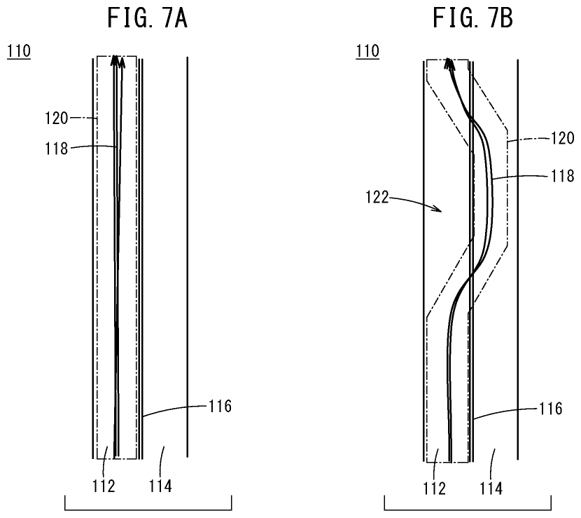

FIGS. 7A and 7B show the change over time of a travel route 118. In each drawing, the travel scenario 100 of FIG. 6 is expressed using a virtual two-dimensional coordinate system (referred to below as a virtual coordinate system 110). In other words, the lane regions 112, 114, and a white line region 116 respectively correspond to the travel lane 102, the opposing lane 104, and the lane mark 106. Here, a case is envisioned in which vehicles 16 travel daily on the travel lane 102.

As shown in FIG. 7A, the vehicles 16 travels substantially along the center line of the travel lane 102, before the road construction is present. As a result, the information acquiring units 54 of the vehicles 16 detect the travel routes 118 along the direction in which the lane region 112 extends (e.g., longitude and latitude coordinate change) and the travel velocities, and accumulate the detected information as the travel information 60. Therefore, the server-side control unit 82 receives and stores the travel information 60 including similar travel routes 118 from a plurality of vehicles 16. The server-side control unit 82 (travel state estimating unit 88) records a travelable region 120 (region surrounded by the one-dot chain line) that contains the plurality of travel routes 118 with a relatively-small statistical variation in the “travelable region” section of the shared-experience map information 96.

As shown in FIG. 7B, after the road construction is present, the vehicles 16 travel while avoiding the construction area 108. As a result, the information acquiring units 54 of the vehicles 16 detect the travel routes 118 along which the vehicles temporarily proceed in the lane region 114 and the travel velocities, and accumulate the detected information as the travel information 60. Therefore, the server-side control unit 82 acquires similar travel information 60 from the plurality of vehicles 16. Accordingly, the server-side control unit 82 records the travelable region 120 (region surrounded by the one-dot chain line) that contains the plurality of travel routes 118 with a relatively large statistical variation in the “travelable region” section of the shared-experience map information 96.

At step S3, the travel state estimating unit 88 identifies a geographical point where the variation among the travel routes 118 was determined to be large in step S2, as a point of concern 122. For example, the travel state estimating unit 88 identifies the location where the travel routes 118 bulge to the right in FIG. 7B (corresponding to the construction area 108 in FIG. 6) as a point of concern 122. The travel state estimating unit 88 may set a point of concern 122 for a location with a small statistical variation, thereby making it possible to provide driving assistance by estimating a travel pattern 128 described further below even at locations with a small variation. In other words, the moving body assistance system 10 can divide all of the roads into predetermined segments (straight lanes, merging lanes, intersections, curves, and the like) and set the points of concern 122 (travel pattern 128). In this way, it is possible to provide driving assistance to the vehicles 16 by constantly comparing the travel conditions to the travel pattern 128. Furthermore, the moving body assistance system 10 may be configured to provide driving assistance by setting a point of concern 122 only in a case where a predetermined condition (a location where driving based on accident information is detected, a low fuel efficiency operating state when a driver has specified a high fuel efficiency operation, or the like) is fulfilled, without considering statistical variation.

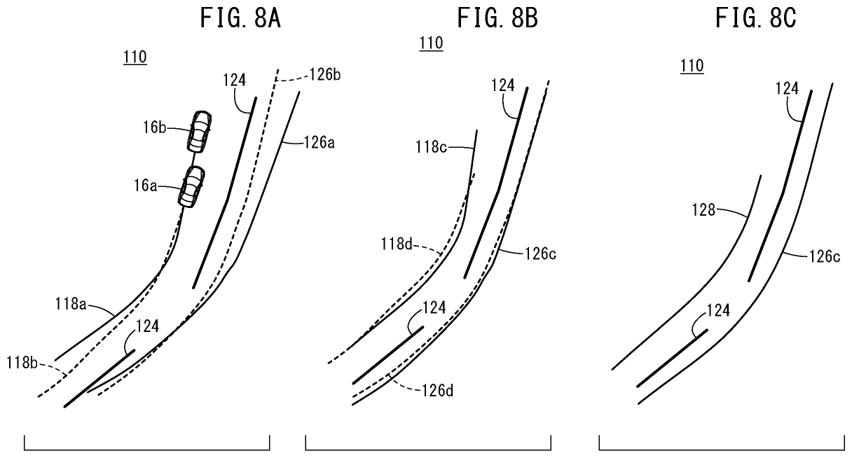

At step S4, the travel state estimating unit 88 estimates a travel pattern 128 that passes through the point of concern 122 identified in step S3, while travelling within the travelable region 120, using a suitable computation. Specifically, the travel state estimating unit 88 estimates the travel pattern 128 by applying an arbitrary statistical process, based on the plurality of pieces of travel information 60 acquired from the plurality of vehicles 16. An example of the travel pattern 128 calculating method is described with reference to FIGS. 8A to 8C.

FIG. 8A schematically shows travel information in a case where a self-position correction is not performed by the position correcting unit 56 (FIG. 2). In this drawing, the travel information 60 acquired from a vehicle 16a is shown by a solid line, and the travel information 60 acquired from a vehicle 16b that is different from the vehicle 16a (or travel information 60 of another vehicle 16b detected by the vehicle 16a) is shown by a dashed line. A white line region 124 is arranged at the correct position (a position without a positioning error) in the virtual coordinate system 110.

Each vehicle 16a and 16b acquires travel information including a positioning error that differs according to the measurement conditions. As a result, a travel route 118a and a boundary line 126a are arranged in a state of being positionally shifted relative to the white line region 124. Similarly, a travel route 118b and a boundary line 126b are arranged in a state of being positionally shifted relative to the white line region 124. The boundary lines 126a and 126b correspond to the right-side boundary line of the travelable region 120.

FIG. 8B schematically shows travel information in a case where the self-position correction has been performed by the position correcting unit 56 (FIG. 2). In this drawing, the travel information 60 acquired from the vehicle 16a is shown by a solid line, and the travel information 60 acquired from the vehicle 16b is shown by a dashed line. The white line region 124 shown by a thick line is arranged at the correct position (a position with no positioning error) in the virtual coordinate system 110.

Each vehicle 16a and 16b acquires travel information 60 that includes no positioning error or a very slight positioning error, due to the position correcting unit 56. As a result, travel routes 118c and 118d are arranged at the correct position (position with no positioning error) in the virtual coordinate system 110. Similarly, boundary lines 126c and 126d are arranged at the correct position (position with no positioning error) in the virtual coordinate system 110.

The travel state estimating unit 88 (FIG. 3) then performs a plurality of statistical processes on the travel information 60 including the travel route 118c that has been positionally corrected, the travel information 60 including the travel route 118d that has been positionally corrected, and the like. In particular, the travel state estimating unit 88 generates various types of travel patterns 128 through statistical processing, based on the travel information 60 of each of the plurality of vehicles 16 at the point of concern 122.

Examples of the plurality of types of travel patterns 128 include an average travel pattern, a high fuel efficiency travel pattern, a smooth travel pattern, and an avoidance travel pattern. The average travel pattern is a travel pattern 128 obtained by averaging the plurality of pieces of travel information 60 in a predetermined time interval at the point of concern 122. As described above, since the route information and velocity information are included in the travel information 60, one travel pattern 128 can be obtained by calculating the average of the plurality of pieces of route information and the plurality of pieces of velocity information. Here, the travel pattern 128 shown in FIG. 8C is an example of route information obtained as the average of the travel route 118c and the travel route 118d.

The high fuel efficiency travel pattern is a travel pattern obtained by extracting the piece of travel information 60 with the best fuel efficiency from among the plurality of pieces of travel information 60 in a predetermined time interval at the point of concern 122. As described above, the travel information 60 includes fuel efficiency information as the host vehicle state information of the vehicle 16. The fuel efficiency information can be acquired by detecting the fuel that is actually consumed or the amount of acceleration and deceleration during travel of the vehicle 16, for example. For the high fuel efficiency pattern calculation, the travel state estimating unit 88 may extract the piece of fuel efficiency information that has the best fuel efficiency and obeys the traffic rules, from among the pieces of fuel efficiency information of the pieces of travel information 60, or may extract several pieces of travel information 60 with good fuel efficiency and average these pieces of travel information 60.

The smooth travel pattern is a travel pattern obtained by extracting the travel information 60 that has the least vehicle 16 manipulation amount, from among the plurality of pieces of travel information 60 in a predetermined time interval at the point of concern 122. As described above, the travel information 60 includes the driver manipulation amount as the host vehicle state information of the vehicle 16. Therefore, the travel state estimating unit 88 can obtain the smooth travel pattern by extracting several pieces of travel information 60 for which the manipulation amount is small, and averaging these pieces of travel information 60. Instead of relating to the driver manipulation amount, the smooth travel pattern may be obtained by including the load placed on the vehicle 16 (acceleration amount) and extracting the piece of travel information 60 having the smallest load.

The avoidance travel pattern is a travel pattern obtained by, when an event has occurred at the point of concern 122, extracting a piece of travel information 60 that avoids the event. Examples of the event include, in addition to the construction described above, an accident, flooding, traffic restrictions including traffic jams, frequent occurrence of accidents, and minor incidents. Minor incidents include activities relating to accidents (collision avoidance due to sudden braking of a vehicle 16, slipping, and the like). The travel state estimating unit 88 estimates that an event has occurred when a plurality of vehicles 16 have exhibited significant changes from the previous travel routes in a short time, for example.

The server-side control unit 82 may include a traffic information acquiring unit 95 that acquires travel road traffic information. For example, the traffic information acquiring unit 95 receives travel road traffic information including event information from a traffic center 95a that gathers various types of event information such as accident information, and stores this event information in association with the shared-experience map information 96. The travel road traffic information includes, in addition to the event information, traffic information of the road being travelled such as the speed limit or closure thereof. In a case where accident information indicating a traffic accident of a vehicle 16 is included in the event information, the traffic information acquiring unit 95 associates the accident information with the shared-experience map information 96 separately from other events.

The travel state estimating unit 88 can calculate the avoidance travel pattern preferentially or without calculating other types of travel patterns if accident information is included in the read shared-experience map information 96 during the estimation of the travel pattern 128. Upon recognizing that a plurality of pieces of travel information 60 have travel routes that do not avoid the event, the travel state estimating unit 88 stops the generation of the avoidance travel pattern. Furthermore, by holding in advance past accident information at the point of concern 122, when there is a possibility of a collision with an opposing vehicle making a right turn due to this vehicle making a large right turn at an intersection, the travel state estimating unit 88 can suggest an average travel pattern with a small turn or suggest deceleration before a curve in order to prevent spinning due to going into a sudden curve at high speed.

Furthermore, the travel state estimating unit 88 may estimate the travel pattern 128 by selecting a piece of travel information 60 that fulfills a predetermined condition from among the plurality of pieces of travel information 60 at the point of concern 122. Examples of this predetermined condition include matching at least one of a time of day, day of the week, month, and weather condition. In other words, even on the same road, if the time of day, day of the week, month, or weather condition is different, the travel information 60 of a vehicle 16 can change significantly. For example, on a road where freezing occurs in winter, the variation in the statistical data becomes large when handling summer travel information 60, and there is a possibility that the travel pattern reliability would drop. Therefore, by using the travel information 60 that fulfills the condition of being from the same month to estimate the travel pattern 128, it is possible to restrict the variation in this type of statistical data. Furthermore, since road conditions even change through the day, 1-hour time units may be set as the predetermined condition and the travel pattern 128 may be computed from the pieces of travel information 60 at this time, for example. The travel state estimating unit 88 may compute the travel pattern 128 by gathering the pieces of travel information 60 at the point of concern 122 for each predetermined condition (time of day, day of the week, month, and weather condition), for example.

Alternatively, the travel state estimating unit 88 may use the weight, body type, tire type, control apparatus type, and the like of the vehicles 16 as data of the vehicles 16, and obtain the travel pattern 128 for each vehicle 16 having the same data. For example, the travel state estimating unit 88 may perform the statistical processing for vehicles 16 having approximately the same body types (compact cars, minivans, oversized vehicles, or the like), and compute a plurality of types of travel patterns 128 (average travel pattern, high fuel efficiency travel pattern, and smooth travel pattern).

The travel state estimating unit 88 can obtain one boundary line 126 from the plurality of boundary lines 126c and 126d, and set a line separating the travelable region 120 and the impossible region based on this boundary line 126. Thus, the travelable region 120 at the point of concern 122 can be obtained. After the travelable region 120 is calculated, the travel state estimating unit 88 may calculate the degree of travel freedom based on a distribution of the plurality of pieces of travel information 60 in the travelable region 120, and estimate a plurality of types of travel patterns 128 according to this degree of travel freedom. For example, the travel state estimating unit 88 calculates all of the four types of travel patterns described above if the degree of travel freedom is high, but only calculates one to three of the four types of travel patterns described above if the degree of travel freedom is low. In this way, the computing of the travel pattern 128 can be made more efficient.

Returning to FIG. 5, at step S5, the travel pattern correspondence unit 90 associates the travelable region 120 calculated in step S3, the plurality of types of travel patterns 128 calculated in step S4, the information (referred to below as additional information) relating to the point of concern 122, and the shared-experience map information 96 with each other. Examples of the additional information include a location ID, the event information, and the type of travel pattern, for example.

At step S6, in order to reflect the associations made in step S5, the server-side control unit 82 updates (adds, alters, or deletes) the travel pattern information 98 (travel patterns 128) stored in the server-side storage unit 84.

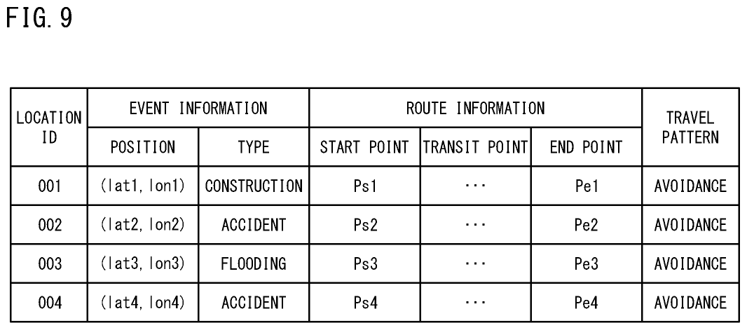

FIG. 9 shows an example of a data structure of the associated travel patterns 128 and additional data at a point of concern 122. The event information included in the additional data includes the location ID and the event information (position and type). Furthermore, the travel pattern 128 includes route information (start point, transit point, and end point) and velocity information (not shown in the drawing), and the plurality of types of patterns are computed as shown above. The travel pattern correspondence unit 90 may make associations with the plurality of types of travel patterns 128, or may select one optimal travel pattern 128 in accordance with the current state from among the plurality of types of travel patterns 128 and make an association with this travel pattern 128.

The “location ID” corresponds to an identifier of the point of concern 122. The “position” of the event information corresponds to a representative position indicating the location of the point of concern 122, and is expressed as a combination of latitude and longitude. The “type” of the event information is the construction, accident, flooding, traffic jam, high occurrence of accidents, minor incidents, or the like described above.

The “route information” includes the positions (both latitude and longitude) of a start point, an end point, and at least one transit point for identifying the shape of the route information included in the travel pattern 128. The “travel pattern” is an association with one of the plurality of types of travel patterns 128 described above (average travel pattern, high fuel efficiency travel pattern, smooth travel pattern, and avoidance travel pattern), according to the event information.

When selecting the optimal travel pattern from among the plurality of types of travel patterns 128, the travel pattern correspondence unit 90 basically selects an avoidance travel pattern if there is event information such as shown in FIG. 9, for example. As another example, in a case where travelling occurs at 25 km/h as the actual condition due to the shape and nature of the road (school road or the like) despite the legal speed limit of the travel road being 40 km/h, the travel pattern correspondence unit 90 provides a travel pattern with 25 km/h as the velocity information by selecting the average velocity pattern. As another example, the travel pattern correspondence unit 90 judges the amount of traffic based on the travel information 60 on the planned travel road, and selects the high fuel efficiency pattern as the basic travel pattern if the amount of traffic is low. Alternatively, in a case where the curvature of the travelable region 120 is greater than or equal to a predetermined amount, the travel pattern correspondence unit 90 may select the smooth travel pattern based on this travelable region 120.

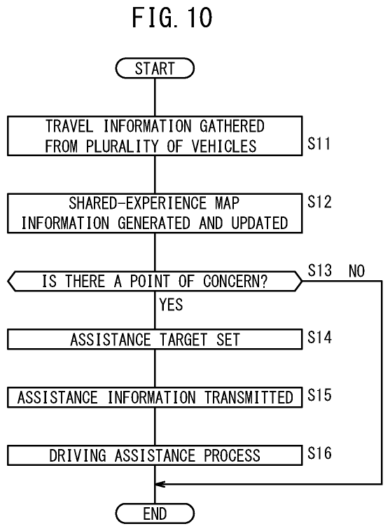

The moving body assistance system 10 implements a second operation (assistance operation for the assistance target) along with the first operation described above. The following describes the second operation of the moving body assistance system 10, while referencing the flow chart of FIG. 10.

At step S11, the server apparatus 12 gathers the pieces of travel information 60 from the plurality of vehicles 16 within the traffic area 14. Prior to this gathering, the external field recognizing unit 50 recognizes the conditions and objects (including traffic participants) around a vehicle 16, based on the external field information output from the external field sensors 32. The behavior analyzing unit 52 analyzes the behaviors of the traffic participants, by tracking the traffic participants (e.g., other vehicles 16) consecutively recognized by the external field recognizing unit 50. The information acquiring unit 54 includes the results of the analysis by the behavior analyzing unit 52 in the travel information 60. In other words, the travel information 60 set in the server apparatus 12 by the vehicle 16 includes the host vehicle state information and the state information (analysis results) of other vehicles. The position correcting unit 56 may correct the position of the vehicles 16 (the host vehicle and the other vehicles) included in the travel information 60 as needed.

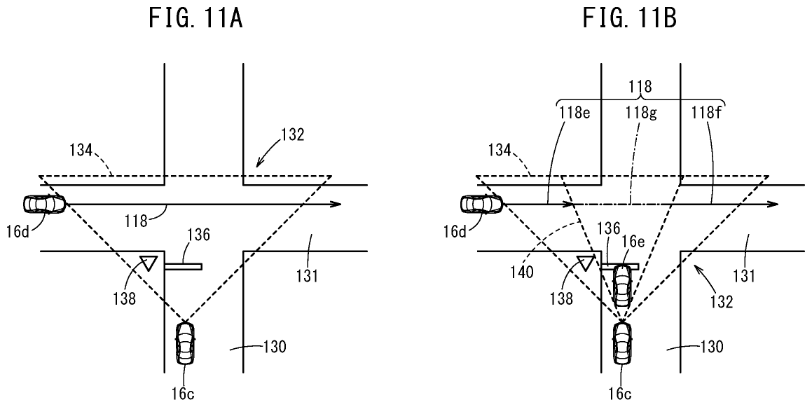

The following describes in detail the calculation method for the travel information of other vehicles, while referencing FIGS. 11A and 11B.

FIG. 11A shows a first travel scenario at an intersection 132 of roads 130 and 131. A vehicle 16c (host vehicle) is travelling on the road 130 and attempts to pass through the intersection 132 while proceeding straight. The substantially triangular region surrounded by dashed lines corresponds to a detection range 134 of the vehicle 16c (external field sensor 32).

On the other hand, a vehicle 16d (other vehicle) attempts to pass through the intersection 132 while proceeding straight on the road 131. In this case, the external field recognizing unit 50 of the vehicle 16c can always recognize the vehicle 16d that is within the detection range 134 of the external field sensor 32. In other words, the information acquiring unit 54 can acquire the travel information 60 concerning the vehicle 16d based on the analysis results of the behavior analyzing unit 52 (vehicle 16d tracking results). The position correcting unit 56 may correct the position of the vehicle 16c (or the vehicle 16d) based on the position of a static object (e.g., a stop line 136 or a sign 138) recognized by the external field recognizing unit 50, using a known self-position estimation technique.

FIG. 11B shows a second travel scenario at the intersection 132 of the roads 130 and 131. The vehicle 16c (host vehicle) is travelling on the road 130 and attempts to pass through the intersection 132 while proceeding straight. However, unlike in FIG. 11A, a vehicle 16e is stopped at a position of the stop line 136 in front of the vehicle 16c. A blind spot range 140 corresponds to a range that temporarily cannot be detected by the vehicle 16c (external field sensor 32), due to occlusion by the vehicle 16e.

In the same manner as in FIG. 11A, the vehicle 16d (other vehicle) attempts to pass through the intersection 132 while travelling straight on the road 131. In this case, the external field recognizing unit 50 of the vehicle 16c temporarily loses sight of the vehicle 16d that enters into the blind spot range 140 from the detection range 134, and again recognizes the vehicle 16d that has exited from the blind spot range 140.

In this case, after losing sight of the vehicle 16d, the behavior analyzing unit 52 determines whether the newly detected moving body is the same as the vehicle 16d. Then, if it is determined to be the same, the behavior analyzing unit 52 may perform interpolation between travel routes 118e and 118f obtained before and after the vehicle 16d was lost sight of. In this way, the information acquiring unit 54 can acquire one route in which the travel routes 118e, 118g, and 118f are sequentially connected, as the travel route 118 of the vehicle 16d. The other vehicle velocity information can be suitably calculated by performing a vector analysis of the other vehicle using video processing, using the velocity difference relative to the host vehicle, or the like.

The driving assistance apparatus 30 transmits, to the server apparatus 12, the travel information 60 including the host vehicle state information and the other vehicle state information temporarily stored in the storage unit 48, either periodically or non-periodically via the V2X communication device 38. The server apparatus 12 acquires the travel information 60 from each vehicle 16 via the base stations 18 and 20, the wide area communication network 22, and the server-side communicating unit 80, and temporarily stores the collection of pieces of travel information 60 in the server-side storage unit 84.

Returning to FIG. 10, at step S12, the travel state estimating unit 88 generates the travel pattern 128 and the travelable region 120 of the point of concern 122, based on the travel information 60 gathered in step S11, and updates the shared-experience map information 96 to the newest state.

At step S13, the server-side control unit 82 reads the shared-experience map information 96 from the server-side storage unit 84 and extracts the point of concern 122 of the travelable region 120 from the shared-experience map information 96. If there is a point of concern 122, the process proceeds to step S14, and if there is no point of concern 122, the current process flow ends.

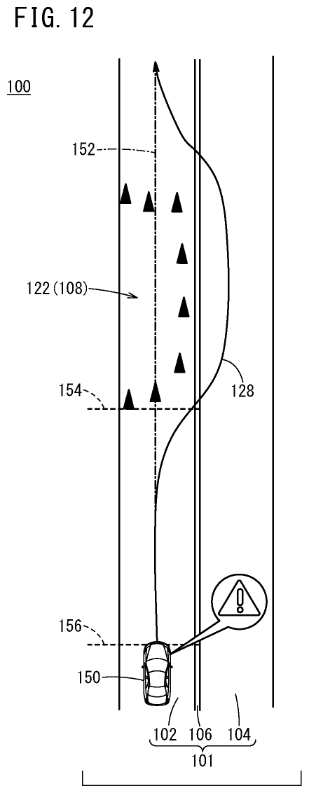

At step S14, the assistance target setting unit 92 sets the assistance target attempting to pass through the point of concern 122. Specifically, the assistance target setting unit 92 sets a vehicle 16 (assistance target vehicle 150) that has a point of concern 122 on a planned travel route 152 (FIG. 12) as the assistance target.

At step S15, the transmission/reception processing unit 94 transmits the travel pattern 128 associated with the point of concern 122 by the travel pattern correspondence unit 90 to the assistance target vehicle 150, via the server-side communicating unit 80, as the assistance information 62. The driving assistance apparatus 30 of the assistance target vehicle 150 acquires the assistance information 62 from the server apparatus 12, via the wide area communication network 22, the base station 18 (20), and the V2X communication device 38, and temporarily stores this assistance information 62 in the storage unit 48.

At step S16, the driving assisting unit 42 performs driving assistance suitable for the travel state of the assistance target vehicle 150, based on the assistance information 62 transmitted in step S15. Here, the driving assisting unit 42 performs a driving assistance operation (specifically a warning, an alert, providing information, deceleration, stopping, steering, or acceleration) for causing the vehicle to travel along the travel pattern 128, according to the control instructions from the driving assistance ECU 40.

FIG. 12 shows an example of driving assistance in the travel scenario 100 of FIG. 6. In this travel scenario 100, the assistance target vehicle 150 is attempting to travel on the travel lane 102 along the planned travel route 152 indicated by the single-dot chain line arrow. However, a construction area 108 is set up in front of the assistance target vehicle 150 in the travel lane 102.

When the assistance target vehicle 150 reaches an assistance start position 156 (e.g., a position that is a predetermined distance in front of an identified position 154 of the construction area 108), the driving assisting unit 42 starts the assistance operation for the assistance target vehicle 150.

For example, in a case where the assistance target vehicle 150 is travelling according to automated driving, acceleration control by the drive force apparatus 72, steering control by the steering apparatus 74, or deceleration control by the braking apparatus 76 is performed automatically, such that the assistance target vehicle 150 passes through the point of concern 122 (construction area 108) along the travel pattern 128. Alternatively, in a case where the assistance target vehicle 150 is travelling according to manual driving, the information providing apparatus 70 provides notification to the driver to travel along the travel pattern 128 included in the assistance information 62.

For example, if above the average velocity, the assistance target vehicle 150 using automated driving automatically decelerates based on the deceleration information of the travel pattern 128. Alternatively, the driver is notified of the deceleration by delivery of a display or sound encouraging deceleration by the assistance target vehicle 150 using manual driving. Furthermore, concerning fuel efficiency, the assistance target vehicle 150 compares the fuel efficiency of the host vehicle and of the travel pattern 128 (high fuel efficiency pattern) of the assistance information 62, and delivers a display or a sound indicating the fuel efficiency value or the high fuel efficiency travel pattern (route information and velocity information) if the fuel efficiency is low.

While passing through an intersection or curve, the assistance target vehicle 150 using automated driving travels at a velocity that does not exceed an average value, and the assistance target vehicle 150 using manual driving provides guidance or the like that is a velocity warning if the velocity exceeds the average value.

Furthermore, the moving body assistance system 10 can set an accident occurrence location (collision (SRS signal) detection: airbag activation, sudden distortion or panning of a camera image, sudden change of a gyro sensor detection value, sudden deviation from the travel pattern, operation of the collision avoidance systems of other traffic participants) as the point of concern 122. In other words, the server-side control unit 82 stores an accident travel pattern, which is the travel pattern used when an accident has occurred, in the shared-experience map information 96, and performs a comparative analysis with the current travel information 60 (travel route and travel velocity) of the assistance target vehicle 150. Then, as an example, when it has been predicted that the current travel information 60 of the assistance target vehicle 150 and the accident travel pattern are highly correlated (have the same conditions), a travel pattern that differs from the accident travel pattern can be computed and selected to avoid the travel pattern in which an accident occurred. Alternatively, the information providing apparatus 70 of the vehicle 16 that received the assistance information 62 from the server apparatus 12 can also simply provide detailed information such as “accidents occur frequently at this intersection” to raise the awareness of the driver of the vehicle 16.

### [Effects Realized by the Moving Body Assistance System 10]

As described above, the moving body assistance system 10 includes the information acquiring unit 54 configured to acquire the travel information 60 of the vehicle 16 (moving body); the map information generating unit 86 configured to generate the shared-experience map information 96; the travel state estimating unit 88 configured to estimate the travelable region 120 for the vehicle 16 at the point of concern 122 in the shared-experience map information 96 and the travel pattern 128 for passing through the travelable region 120, using a plurality of pieces of acquired travel information 60; the assistance target setting unit 92 configured to set the assistance target vehicle 150 (moving body) attempting to pass through the point of concern 122 as the assistance target; and the assisting unit (driving assisting unit 42 and transmission/reception processing unit 94) configured to provide the estimated travel pattern 128 to the set assistance target vehicle 150.

Furthermore, the moving body assistance method, which includes an acquisition step (S11) of acquiring the travel information 60 of the vehicle 16 (moving body); a generation step (S12) of generating the shared-experience map information 96; an estimation step (S4) of estimating the travelable region 120 for the vehicle 16 at the point of concern 122 in the shared-experience map information 96 and the travel pattern 128 for passing through the travelable region 120, using a plurality of pieces of acquired travel information 60; and a setting step (S14) of setting the assistance target vehicle 150 (moving body) attempting to pass through the point of concern 122 as the assistance target that is to be assisted with travelling in accordance with the estimated travel pattern 128, is executed by one or more computers.

In this way, with the moving body assistance system 10 and the moving body assistance method, it is possible to use the travel information 60 of a plurality of moving bodies to provide detailed driving assistance, by estimating the travelable region 120 and the travel pattern 128 and assisting with the travel along the travel pattern 128.

In this case, by including route information indicating the travel route of the vehicle 16 in the information forming the travel pattern 128, the moving body assistance system 10 can guide the vehicle 16 that received the travel pattern 128 according to the route information. Therefore, it is possible to cause the vehicle 16 to travel in accordance with an average route according to other vehicles 16, a high fuel efficiency route, a smooth route, a route that avoids events, and the like, for example.

By further including the velocity information indicating the travel velocity of the vehicle 16 in the information forming the travel pattern, it is possible to guide the vehicle 16 that received the travel pattern 128 in accordance with the velocity information. Therefore, it is possible to cause the vehicle 16 to travel in accordance with an average route according to other vehicles 16, a high fuel efficiency route, a smooth route, a route that avoids events, and the like, for example.

By selecting an optimal travel pattern 128 from among the plurality of types of travel patterns 128 estimated by the travel state estimating unit 88, using the travel pattern correspondence unit 90, the moving body assistance system 10 can cause the vehicle 16 to travel favorably in accordance with this travel pattern.

Here, by having the plurality of types of travel patterns 128 include two or more of the average travel pattern, the high fuel efficiency travel pattern, and the smooth travel pattern, the vehicle 16 can travel according to a suitable travel pattern 128 corresponding to the conditions at the point of concern 122.

By estimating the avoidance travel pattern as one of the plurality of types of travel patterns, the moving body assistance system 10 can guide the vehicle 16 in a manner to reliably avoid events such as road construction and accident locations.

Furthermore, by further including the traffic information acquiring unit 95 that stores the event information included in the travel road traffic information with the shared-experience map information 96, the moving body assistance system 10 can more reliably recognize the event information. As a result, the travel state estimating unit 88 can more accurately estimate the avoidance travel pattern.

In particular, when the event is accident information of the vehicle 16, by storing the accident information in the shared-experience map information 96 separately from the other events, the traffic information acquiring unit 95 can acquire more detailed accident information and can implement travel that avoids traffic accidents.

When there is determined to be a high correlation between the current travel information 60 of the vehicle 16 and the accident travel pattern, the travel pattern correspondence unit 90 selects a travel pattern 128 differing from the accident travel pattern. Therefore, it is possible to perform driving assistance in a manner to not invite accidents.

By calculating the degree of travel freedom based on the distribution of a plurality of pieces of the travel information 60 concerning the travelable region 120, the travel state estimating unit 88 can provide a plurality of types of travel patterns 128 when the degree of travel freedom is high and allow any of these travel patterns 128 to be adopted on the vehicle 16 side, for example. On the other hand, when the degree of travel freedom is low, the travel state estimating unit 88 can provide one travel pattern 128 to guide the vehicle 16 in accordance with the provided travel pattern 128.

By having the travel state estimating unit 88 estimate the travel pattern by selecting a piece of travel information 60 that fulfills a predetermined condition from among the plurality of pieces of travel information 60 at the point of concern 122, it is possible to acquire a travel pattern 128 corresponding to more realistic conditions, and to more favorably assist the vehicle 16.

In addition to the above configuration, by having the predetermined condition be a condition of being identical with respect to one of a time of day, day of the week, month, and weather condition, the travel state estimating unit 88 can compute a travel pattern 128 having the same condition.

By including the route information and velocity information of one vehicle 16 in the travel information 60, the moving body assistance system 10 can easily estimate the travel pattern 128 based on these pieces of information.

Furthermore, by including the fuel efficiency information detected or calculated by the one vehicle 16 in the travel information 60, the moving body assistance system 10 can easily estimate the high fuel efficiency travel pattern based on the fuel efficiency information.

In the moving body assistance system 10, the travel information 60 includes at least one of the weight, body type, tire type, and control apparatus type of the vehicle 16 as the data of the vehicle 16. Therefore, it is possible to calculate the travel pattern 128 for each vehicle 16 having the same data (weight, body type, and the like). In other words, it is possible to provide more detailed travel assistance according to the data of the vehicle 16.

By including the external field recognizing unit 50 and the behavior analyzing unit 52 and acquiring the travel information 60 of other vehicles 16 with the information acquiring unit 54, the moving body assistance system 10 can acquire the travelable region 120 and the travel pattern 128 using the travel information 60 of other vehicles 16.

By performing interpolation between routes obtained before and after losing sight of another vehicle 16 with the behavior analyzing unit 52, the moving body assistance system 10 can fill out the travel information 60 of the other vehicle 16. As a result, the accuracy of the travelable region 120 and the travel pattern 128 can be increased.

By correcting the position of the vehicle 16 based on the position of a static object, using the position correcting unit 56, the moving body assistance system 10 can increase the accuracy of the travel information 60 (particularly the route information). Accordingly, it is possible to compute the travelable region 120 and the travel pattern 128 even more accurately.

By performing information communication between the server apparatus 12 and the vehicle 16 and implementing processing, the moving body assistance system 10 can compute the travelable region 120 and the travel pattern 128 based on a large amount of travel information 60 in the server apparatus 12.

### [Supplement]

The present invention is not limited to the embodiments described above, and various alterations may be made without deviating from the scope of the present invention. Alternatively, the various configurations may be arbitrarily combined with each other, as long as this does not cause a technical contradiction.

For example, the moving body assistance system 10 according to the embodiment described above is configured to acquire the travel information 60 and transmit the assistance information 62 to the vehicle 16 travelling on an outdoor road as the target. However, the moving body assistance system 10 is not limited to this, and can be configured to assist with the travel of an indoor moving body (moving robot or the like). In other words, a configuration can be used in which the server apparatus 12 communicates information with a plurality of moving robots (not shown in the drawings), the server apparatus 12 acquires the travel information 60 of the plurality of moving robots, and the travelable region 120 and travel pattern 128 are computed (estimated). At this time, a moving robot (one moving body) can obtain its own travel information 60, and can also analyze the movement of people (other moving bodies) or the like whose image is captured during travel of the moving robot, to obtain the route information and the velocity information as the travel information 60.

Furthermore, the server apparatus 12 can automatically generate the travelable region 120 and the travel pattern 128 by acquiring the travel information 60 from the moving bodies, even at a location where there is no information concerning a road network (route map or node link map) to serve as the foundational map in the shared-experience map information 96. Thus, the server apparatus 12 can generate map information by the vehicle 16 (moving body) in which the external field sensor 32 and the host vehicle state sensor 34 are mounted (without a dedicated vehicle for measurement).

What is claimed is:

1. A moving body assistance system comprising:
an information acquiring unit configured to acquire travel information of a moving body;
a map information generating unit configured to generate map information;
a travel state estimating unit configured to estimate a travelable region for the moving body at a point of concern in the map information and a travel pattern for passing through the travelable region, using a plurality of pieces of the travel information acquired by the information acquiring unit;
an assistance target setting unit configured to set a moving body attempting to pass through the point of concern as an assistance target; and
an assisting unit configured to provide the moving body set by the assistance target setting unit with the travel pattern estimated by the travel state estimating unit.

2. The moving body assistance system according to claim 1, wherein information forming the travel pattern includes at least route information indicating a travel route of the moving body.

3. The moving body assistance system according to claim 2, wherein the information forming the travel pattern further includes velocity information indicating a travel velocity of the moving body.

4. The moving body assistance system according to claim 1, wherein the travel state estimating unit is configured to estimate a plurality of types of the travel pattern at the point of concern, and
the moving body assistance system further comprises a travel pattern correspondence unit configured to select an optimal travel pattern to be provided to the moving body, from among the estimated plurality of types of travel patterns.

5. The moving body assistance system according to claim 4, wherein the plurality of types of travel patterns include two or more of:
an average travel pattern obtained as an average of a plurality of the travel patterns within a predetermined time interval at the point of concern,
a high fuel efficiency travel pattern obtained by extracting the travel pattern having the best fuel efficiency among the plurality of the travel patterns within a predetermined time interval at the point of concern, and
a smooth travel pattern obtained by extracting a travel pattern with the least manipulation amount of the moving body among the plurality of the travel patterns within a predetermined time interval at the point of concern.

6. The moving body assistance system according to claim 4, wherein the travel state estimating unit is configured to acquire an occurrence of an event at the point of concern, and estimate an avoidance travel pattern that avoids the event, as one of the plurality of types of travel patterns.

7. The moving body assistance system according to claim 6, further comprising a traffic information acquiring unit configured to acquire travel road traffic information,
wherein the traffic information acquiring unit is configured to store event information included in the acquired travel road traffic information in association with the map information.

8. The moving body assistance system according to claim 7, wherein when the event is accident information of the moving body, the traffic information acquiring unit is configured to store the accident information in the map information separately from other events.

9. The moving body assistance system according to claim 8, wherein when a degree of freedom of the travel pattern in the travelable area is high, the travel pattern correspondence unit is configured to compare an accident travel pattern, which is the travel pattern when the accident information has occurred, to current travel information of the moving body, and
when it is determined that there is a high correlation between the current travel information of the moving body and the accident travel pattern, the travel pattern correspondence unit is configured to select a travel pattern differing from the accident travel pattern.

10. The moving body assistance system according to claim 1, wherein the travel state estimating unit is configured to calculate a degree of travel freedom based on a distribution of a plurality of pieces of the travel information of the travelable region.

11. The moving body assistance system according to claim 1, wherein the travel state estimating unit is configured to estimate the travel pattern by selecting the travel information that satisfies a predetermined condition from among the plurality of pieces of the travel information at the point of concern.

12. The moving body assistance system according to claim 11, wherein the predetermined condition includes any one of the same time of day, day of the week, month, and weather condition.

13. The moving body assistance system according to claim 1, wherein the travel information includes route information and velocity information of one moving body detected by the one moving body.

14. The moving body assistance system according to claim 13, wherein the travel information includes fuel efficiency information detected or calculated by the one moving body.

15. The moving body assistance system according to claim 1, wherein the travel information includes at least one of weight, body type, tire type, and control apparatus type of the moving body as data of the moving body.

16. The moving body assistance system according to claim 1, further comprising:
an external field recognizing unit configured to recognize an external field of one moving body; and
a behavior analyzing unit configured to analyze travel behavior of another moving body, by tracking the other moving body sequentially recognized by the external field recognizing unit,
wherein the information acquiring unit is configured to acquire the travel information of the other moving body based on a result of the analysis by the behavior analyzing unit.

17. The moving body assistance system according to claim 16, wherein
after losing sight of the other moving body during the tracking, the behavior analyzing unit is configured to determine whether a newly detected moving body is the same as the other moving body, and
if the moving bodies are the same, the behavior analyzing unit is configured to perform interpolation between routes obtained before and after the other moving body was lost sight of.

18. The moving body assistance system according to claim 16, further comprising a position correcting unit configured to correct a position of the one moving body or a position of the other moving body, based on a position of a static object recognized by the external field recognizing unit.

19. The moving body assistance system according to claim 1, comprising a server apparatus including the map information generating unit, the travel state estimating unit, the assistance target setting unit, and the assisting unit,
wherein the moving body is a vehicle configured to travel on an outdoor road, includes the information acquiring unit, and is configured to perform information communication with the server apparatus.

20. The moving body assistance system according to claim 1, comprising a server apparatus including the map information generating unit, the travel state estimating unit, the assistance target setting unit, and the assisting unit,
wherein the moving body is a robot configured to move indoors, includes the information acquiring unit, and is configured to perform information communication with the server apparatus.

21. A moving body assistance method that is executed by one or more computers, the method comprising:
an acquisition step of acquiring travel information of a moving body;
a generation step of generating map information;
an estimation step of estimating a travelable region for the moving body at a point of concern in the map information and a travel pattern for passing through the travelable region, using a plurality of acquired pieces of the travel information; and
a setting step of setting a moving body attempting to pass through the point of concern as an assistance target that is to be assisted with travelling in accordance with the estimated travel pattern.
